(19) United States
(12) Patent Application Publication
(10) Pub. No.: US 2004/0067194 A1
(43) Pub. Date: Apr. 8, 2004

(54) Torch in water will slit water into oxygen and hydrogen

(76) Inventor: Hanna Albert Awad, Ajaltoun (LB)

Correspondence Address: HANNA ALBERT AWAD, 4721 Nathan West, Sterling Heights, MI, 48310, US

(21) Appl. No.: 10/263,747

(22) Filed: Oct. 4, 2002

(51) Int. Cl. C01B 3/04

(52) U.S. Cl. 423/658.2

(57) ABSTRACT

a torch of acetylene or any other combustible will light and ignite more in water.

The fire has several colors: blue, yellow, red, green, etc. . .

One color for fire of a torch will ignite more in water and split water into oxygen and hydrogen while burning a small portion of them.

The oxygen and hydrogen will get to the surface and can be split by compressing the mix. The liquefaction point of oxygen is different from the liquefaction point of hydrogen, therefore we get by compressing the mix a liquid and a gas. And the mix is separated.

### CIRCUMSTANCES AND DATE OF CONCEPTION

a torch of acetylene or any other combustible will light and ignite more in water.

The fire has several colors: blue, yellow, red, green, etc. . .

One color for fire of a torch will ignite more in water and split water into oxygen and hydrogen while burning a small portion of them.

The oxygen and hydrogen will get to the surface and can be split by compressing the mix. The liquefaction point of oxygen is different from the liquefaction point of hydrogen, therefore we get by compressing the mix a liquid and a gas. And the mix is separated.

The color of the fire is determined by a dimensionless parameter like the reynold's number which determine flow.

### DESCRIPTION OF THE INVENTION

PURPOSE: to generate oxygen and hydrogen which is a combustible.

PARTS: one color for fire of a torch in water.

USE: the torch in water will split water into oxygen and hydrogen and they get to the surface.

By compressing the mix we can separate oxygen from hydrogen and using hydrogen as a combustible.

NOVEL FEATURES: a unique way of generating oxygen and hydrogen.

ADVANTAGES: generating hydrogen with negligible cost

TESTING RESULTS: one of the colors for fire of a torch will split water into oxygen and Hydrogen, while the torch is in water and it will burn a negligible amount of them.

1. I claim the right of any use of this process to generate oxygen and hydrogen:
I claim the right of the trade of oxygen and hydrogen produced this way.
I claim the right of the use of the dimensionless parameter that determine the color of fire.
